(19) United States
(12) Patent Application Publication
(10) Pub. No.: US 2014/0105411 A1
(43) Pub. Date: Apr. 17, 2014

(54) METHODS AND SYSTEMS FOR KARAOKE ON A MOBILE DEVICE

(71) Applicants: Peter Santos, Los Altos, CA (US); Eric Skup, Sunnyvale, CA (US); Carlo Murgia, Sunnyvale, CA (US); Sangnam Choi, San Jose, CA (US); Tony Verma, San Francisco, CA (US); Ludger Solbach, Mountain View, CA (US)

(72) Inventors: Peter Santos, Los Altos, CA (US); Eric Skup, Sunnyvale, CA (US); Carlo Murgia, Sunnyvale, CA (US); Sangnam Choi, San Jose, CA (US); Tony Verma, San Francisco, CA (US); Ludger Solbach, Mountain View, CA (US)

(21) Appl. No.: 14/055,621

(22) Filed: Oct. 16, 2013

Related U.S. Application Data
(60) Provisional application No. 61/714,598, filed on Oct. 16, 2012.
(60) Provisional application No. 61/788,498, filed on Mar. 15, 2013.

(51) Int. Cl. H04R 3/00

(52) U.S. Cl. CPC H04R 3/002
USPC 381/66

(57) ABSTRACT

Systems and methods for providing karaoke recording and playback on mobile devices are provided. The mobile device may play music audio and associated video, and receive via one or more microphones a mix of a user voice, the music, and background noise. The mix is stored both in its original form and as processed to enhance voice and sound through noise suppression and other processing. Stored audio may be uploaded through a communications network to a cloud based computing environment for listening on other mobile devices. Selectable playing control and recording options may be provided. Audio cues may be determined during signal processing of the original acoustic sound and be stored on the mobile device. During playback of recorded audio and, optionally, associated video, the original acoustic sound, recorded cues, and user selectable optional processing may be used to remix during playback, while retaining the original recording.

### CROSS-REFERENCE TO RELATED APPLICATIONS

This application claims the benefit of the U.S. Provisional Application No. 61/714,598, filed Oct. 16, 2012, and U.S. Provisional Application No. 61/788,498, filed Mar. 15, 2013. The subject matter of the aforementioned applications are incorporated herein by reference for all purposes to the extent such subject matter is not inconsistent herewith or limiting hereof.

### FIELD

The present application relates generally to audio processing and more specifically, to providing a karaoke system for a mobile device.

### BACKGROUND

Karaoke is a form of interactive entertainment or video game in which (amateur) singers sing along with pre-recorded music (e.g., a music video). The pre-recorded music is typically a known song without the lead vocal (i.e., background music). Lyrics are usually displayed on a video screen, along with a moving symbol, changing color, or music video images, to guide the singer. Backup vocals may also be included in the pre-recording to guide the singer.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to embodiments of the present disclosure, a system for karaoke on a mobile device may comprise one or more mobile devices and a computing cloud. In some embodiments, the mobile device comprises at least speakers, a user interface, two or more microphones, and an audio processor. The mobile device may be configured to receive a music track for a song. In some embodiments, a user, via a user interface, may provide options to apply effects to a played music track. In some embodiments, the mobile device may be further configured to record, via microphones, a sound comprising a mix of a user voice and a music audio track. The recording process may be controlled by a user by providing recording control options via the user interface. The recorded sound may be further processed in order to enhance voice and add sound effects based on the processing control options provided by the user via the user interface. In some embodiments, the recorded sound may be re-aligned and mixed with the original music track. In some embodiments, the recorded sound may be uploaded to the cloud and provided for playback on a mobile device.

Embodiments described herein may be practiced on any device configured to receive and/or provide audio such as, but not limited to, personal computers (PCs), tablet computers, phablet computers; mobile devices, cellular phones, phone handsets, headsets, media devices, and the like.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements and in which:

FIG. 1 is a system for karaoke recording and playback on a mobile device, according to an example embodiment.

FIG. 2 is a block diagram of an example mobile device.

FIG. 3 is an exemplary diagram illustrating general operations of karaoke recording and playback system that may be carried out using the mobile device.

FIG. 4 is a block diagram of a system for recording and playback on a mobile device, according to some embodiments.

FIG. 5 is a block diagram of a system for recording and playback on a mobile device, according to various embodiments.

FIG. 6 is a block diagram of a system for recording and playback on a mobile device, according to various embodiments.

FIG. 7 is a block diagram of a system for recording and playback on a mobile device, according to various embodiments.

FIG. 8 is a block diagram of a system for recording and playback on a mobile device, according to various embodiments.

FIG. 9 is a block diagram of a system for recording and playback on a mobile device, according to various embodiments.

FIG. 10 is a flowchart diagram for a method for a karaoke recording and playback on a mobile device, according to some embodiments.

FIG. 11 is example of a computing system implementing a system of karaoke recording on a mobile device according to an example embodiment.

### DETAILED DESCRIPTION

The present disclosure provides example systems and methods for karaoke on one or more mobile devices. Embodiments of the present disclosure may be practiced on any mobile device configurable, for example, to play a music track, record an acoustic sound, process the acoustic sound, store the acoustic sound, transmit the acoustic sound, and upload the processed acoustic sound through a communications network to social media in a cloud, for instance. While some embodiments of the present disclosure are described with reference to operation of a mobile device, the present disclosure may be practiced with any computer system having an audio device for playing and recording sound.

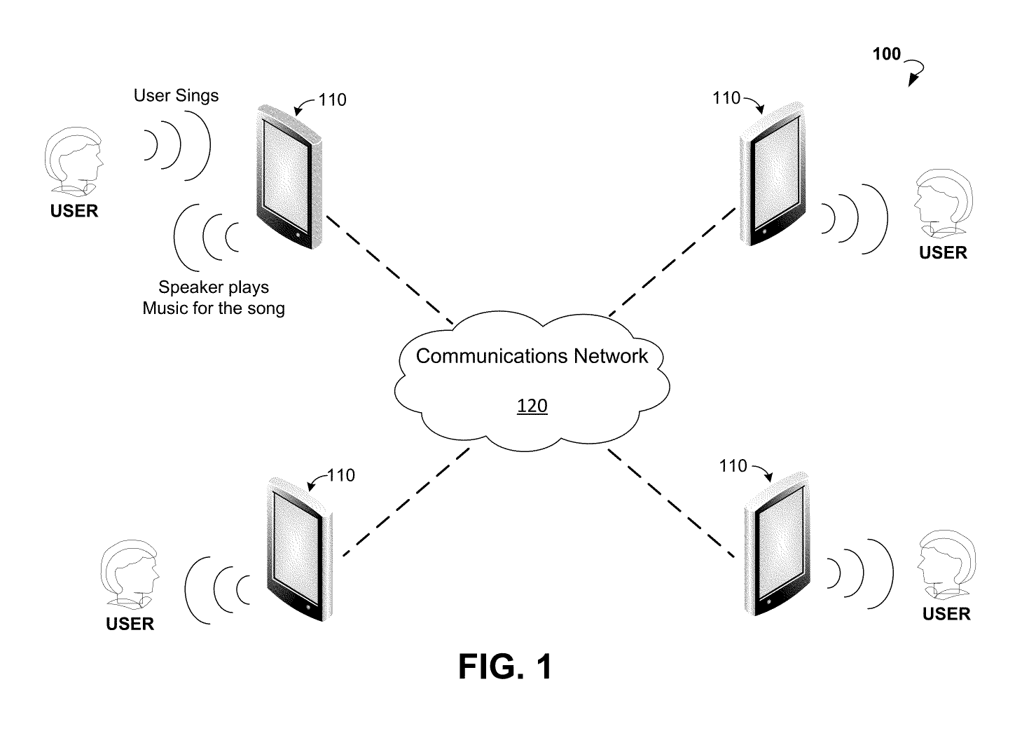

Referring now to FIG. 1, a system 100 for karaoke recording and playback on a mobile device is shown. The system 100 may comprise one or more mobile devices 110 and a communications network 120 (e.g., a cloud computing environment or “cloud”). Although examples may be described and shown herein with reference to the communications network 120 being a cloud, the communications network 120 may be, but is not limited to, a cloud. Each of the mobile devices 110 may be configurable at least to play an audio sound, record an acoustic sound, process the acoustic sound, and store the acoustic sound. In some embodiments, mobile devices 110 may be further configurable to upload the acoustic sound through the communications network 120 to a cloud-based computing environment.

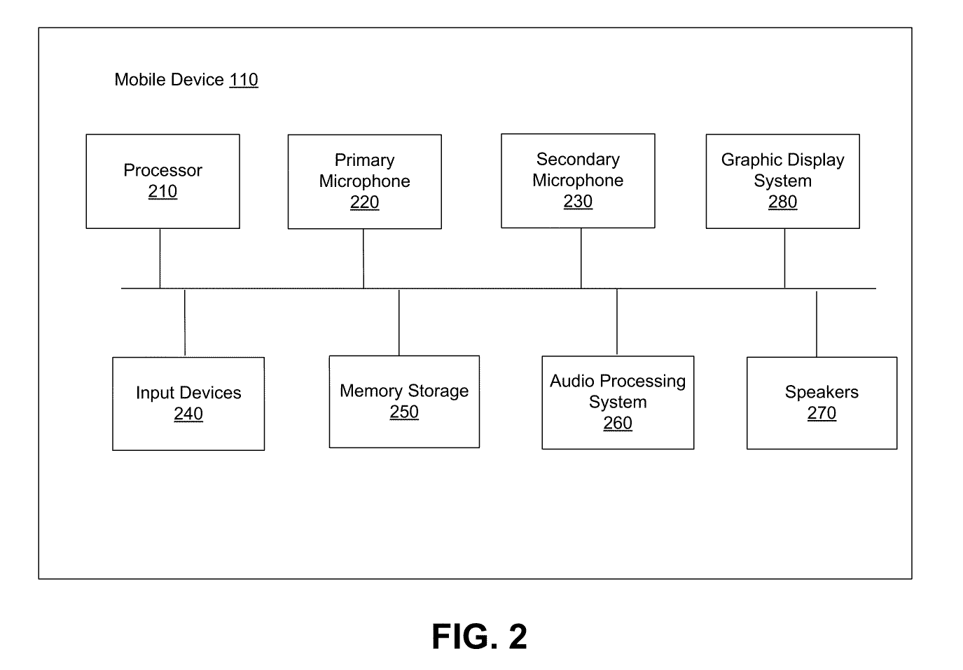

FIG. 2 is a block diagram of an example mobile device 110. In the illustrated embodiment, the mobile device 110 includes a processor 210, a primary microphone 220, an optional secondary microphone 230, input devices 240, memory storage 250, an audio processing system 260, transducer(s) 270 (e.g., speakers, headphones, earbuds, and the like), and graphic display system 280. The audio device 110 may include additional or other components necessary for mobile device 110 operations. For example, the audio processing system 260 may include an audio input/output module for receiving audio inputs and providing audio outputs, a mixing module for combining audio and optionally video signals, a signal processing module for performing signal processing described herein and a communications module for providing for communications via a communications network described herein, e.g., with a cloud (based environment). The mobile device 110 may include fewer components that perform similar or equivalent functions to those depicted in FIG. 2.

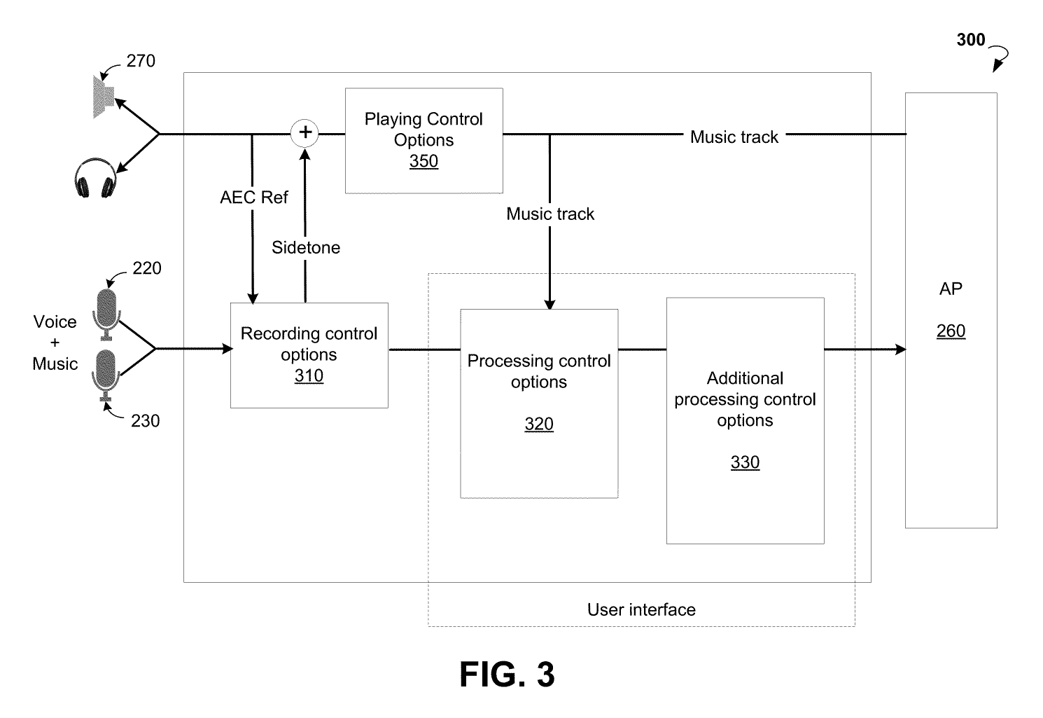

FIG. 3 is an exemplary diagram illustrating general operations of karaoke recording and playback system 300 that may be carried out using the mobile device 110. A music track for a song may be played via one or more transducers 270 (e.g., speakers, headphones, earbuds, and the like), of the mobile device 110. In some embodiments, a video and/or text associated with the music track may be played using the graphic display system of the mobile device 110. In some embodiments, a user interface may be provided to receive playing control options 350. The user interface may be provided via the graphic display system of mobile device 110. The audio processing system 260 is configured to enhance the music track by applying the playing control options 350. The playing control options 350 may include stereo widening, applying a filter, for example, a parametric and graphical equalizer, a virtual bass control, reverbing, etc.

Musical sound produced by transducer(s) 270 of mobile device and a voice of a singing user may be captured by microphones 220 and 230. Although two microphones are shown in this example, other number of microphones may be used in some embodiments. The audio processing system 260 may be configured to record an acoustic sound comprising a mix of the music sound and the voice. Acoustic sounds may comprise singing from one or more singers, background music (e.g., from the one transducers 270), and ambient sounds (e.g., noise and echo). In some embodiments, a user interface may be provided to receive recording control options 310. The audio processing system 260 may be configured to apply the recording control options 310 to the recording process. The recording control options 310 may include noise suppression, acoustic echo cancelation, suppression of the music component in acoustic sound, automatic gain control, and de-reverbing.

In some embodiments, the audio processing system 260 may be further configured to re-align and mix the recorded acoustic sound with the original music track. In some embodiments, a user interface may be provided to receive processing control options 320 to control the re-alignment and mixing of the recorded acoustic sound and original music track. The processing control options 320 may include constant voice volume, and asynchronous sample rate conversion, and “dry music.” The “dry music” option may allow leaving the recorded acoustic sound as is.

In some embodiments, the audio processing system 260 may be further configured to process the recorded acoustic sound. The additional processing control options 330 may be received via a user interface. The additional processing control options 330 may include a parametric and graphic equalizer filter, a multi-band compander, a dynamic range compressor, and an automatic pitch correction.

In some embodiments, the karaoke recording system 300 may include a monitoring channel which may allow a singer or a user to listen (e.g., via transducer(s) 270 to the signal processed acoustic sound when processing and recording the signal processed acoustic sound. The real-time signal processing may be performed when karaoke recording systems are recording the acoustic sound and during playback.

Various embodiments of the karaoke recording and playback system 300 may store raw or original acoustic sound received by the one or more microphones. In some embodiments, signal processed acoustic sounds may be stored. The original acoustic sounds may include cues. Further cues may be determined during signal processing of the original acoustic sound during recording and stored with the original acoustic signals. The cues may include one or more of inter-microphone level difference, level salience, pitch salience, signal type classification, speaker identification, and the like. During playback of recorded audio and, optionally, associated video, the original acoustic sound and recorded cues may be used to alter the audio provided during playback.

By recording the original acoustic sounds and, optionally, the signal processed acoustic sounds, different audio modes, and signal processing configurations may be used to post process the original acoustic sound and may create a different audio effect both directional and non-directional. A user listening to and, optionally, watching the recording may explore options provided by different audio modes without irreversibly losing the original acoustic sounds.

Some embodiments of the karaoke recording system 300 may provide a user interface during playback of recorded audio and optionally video. The user interface may include, for example, one or more controls using buttons, icons, sliders, menus, and so forth for receiving indicia from a user during playback. The controls may include graphics, text, or both. During playback, the user may, for example, play, stop, pause, fast forward, and rewind the recorded audio and, optionally, associated video. The user may also change the audio mode, for example, to reduce noise, focus on one or more sound sources, and the like, during playback. In various embodiments, one or more buttons may be provided which, for example, enable the user to control the playback, and change to a different audio mode or toggle among two or more audio modes. For example, there may be one button corresponding to each audio mode; pressing one of the buttons selects the audio mode corresponding to that button.

According to various embodiments of the karaoke recording system, the user interface may also include controls to combine two or more audio and, optionally, video recordings. For example, each recording may have been recorded at the same or different times, and on the same or different karaoke recording systems. Each recording may be of the same singer or singers (e.g., for a duet, trio, and so forth) where they sing together on one recording, for instance or of different singers. Each recording may be of the same song, complimentary song, similar song, or completely different song. In various embodiments, the controls may allow the user to select recordings to combine, align or synchronize the recordings, control playback of the resulting combination (e.g., duet, trio, quartet, quintet, and so forth), and change to a different audio mode or toggle among two or more audio modes. In some embodiments, alignment or synchronization of the recordings may be performed automatically.

In various embodiments, indicia may be received through the one or more buttons during playback and in real time, the audio provided may be changed responsive to the indicia, without stopping the playback. The audio provided during playback may be in accordance with a default audio mode or a last audio mode selected, until initial or further indicia respectively from the user is received. There may be latency between the user pressing a button and a change in the audio mode, however in some embodiments, the lag may not be perceptible or may be acceptable to the user. For example, the delay may be about 100 milliseconds. In some embodiments, the audio recording system may include faster than real-time signal processing.

According to various embodiments of the karaoke recording system, the audio modes may include two or more of: default, background and foreground, background only, and foreground only. The default audio mode may, for example, include the original and/or signal processed acoustic sound. In the background and foreground audio mode, the audio provided during playback may, for example, include sound from both a primary singer and a background. In the background audio mode, the audio provided during playback may, for example, include sounds from the background to the exclusion of or otherwise attenuate sound from the foreground. In the foreground audio mode, the audio provided during playback may, for example, include sounds from the foreground to the exclusion of or otherwise attenuate sound from the background. Each audio mode may change from the other modes the sound provided during playback such that the audio perspective changes.

The foreground may, for example, include sound originating from one or more audio sources (e.g., singer or singers), background music from speakers, other people, animals, machines, inanimate objects, natural phenomena, and other audio sources that may be visible in a video recording, for instance. The background may, for example, include sound originating from the operator of the karaoke recording system and/or other audio sources (e.g., other primary singers), guidance backup singers, other people, animals, machines, inanimate objects, natural phenomena, and the like.

When combining two or more recordings, there may, for example, be one or more audio modes to include sound from one of the recordings and/or combinations of the recordings to the exclusion of or otherwise attenuate sound from the other recordings not included in the combination. The user interface may also include controls to control the combination of the recordings, e.g., audio mixing, and manipulate each recording's level, frequency content, dynamics, and panoramic position and add effects such as reverb.

A user may switch between different post processing options when listening to the original and/or signal processed acoustic signals in real time, to compare the perceived audio quality of the different audio modes. The audio modes may include different configurations of directional audio capture (e.g., DirAc, Audio Focus, Audio Zoom, etc.) and multimedia processing blocks, (e.g., bass boost, multiband compression, stereo noise bias suppression, equalization filters, and the like). The audio modes may enable a user to select an amount of noise suppression, direction of an audio focus toward one or more singers (e.g., in the same or different recordings, foreground, background, both foreground and background, and the like).

In various embodiments, aspects of the user interface may appear in a screen or display during playback, for example, in response to the user touching a screen. Controls may include buttons for controlling playback (e.g., rewind, play/pause, fast forward, and the like), and controlling the audio mode (e.g., representing emphasis on one or more different recordings in a combination of recordings, and in each recording the foreground only; background only; a combination of foreground and background; a combination of foreground, background, and other sounds or properties of sound that were not included in the original acoustic sound). In some embodiments, in response to a user selection, the audio may dynamically change after a slight delay, but stay synchronized with an optional video, such that the sound selected by the user is provided.

In some embodiments, the audio provided, according to one or more audio mode selections made during playback, may be stored. In various embodiments, the stored acoustic sounds may reflect at least one of the default audio mode, a last audio mode selected, and audio modes selected during playback and applied to respective segments of the original audio sounds and/or processed audio sounds. According to some embodiments, the stored audio may be stored (e.g., on the mobile device, in a cloud computing environment, etc.) and/or disseminated, for example, via social media or sharing website/protocol.

In some embodiments, a user may play a recording of comprising audio and video portions. A user may touch or otherwise actuate a screen during playback and in response buttons may appear (e.g., rewind, play/pause, fast forward buttons, scene, narrator, and the like). The user may touch or otherwise actuate the foreground button and in response, the audio recording system is configured such that the video portion may continue playing with a sound portion modified to provide an experience associated with the foreground audio mode. The user may continue listening to and watching the recording to determine if the user prefers the foreground audio mode. The user may optionally rewind to an earlier time in the recording if desired. Similarly, the user may touch or otherwise actuate a background button and in response, the audio recording system is configured such that the video portion may continue playing with a sound portion modified to provide an experience associated with the background audio mode. The user may continue listening to the recording to determine if the user prefers the background audio mode.

Alternatively or in addition, in certain embodiments, a user may select and play two recordings of the same song by different singers from two different karaoke recording systems. An optional video portion displayed to the user may, for example, include video from the two recordings, e.g., side by side, and/or include the video from one of the recordings based on the audio mode selected. The user may touch or otherwise actuate a button and in response, the audio recording system is configured such that the optional video portion may continue playing with a sound portion modified to emphasize sound from a first recording, e.g. a first audio mode. The user may continue listening to and watching the recording to determine if the user prefers the sound from the first recording. The user may optionally rewind to an earlier time in the recording, if desired. Similarly, the user may touch or otherwise actuate another button and in response, the audio recording system is configured such that the optional video portion may continue playing with a sound portion modified to emphasize sound from a second recording (e.g., a second audio mode). The user may continue listening to the recording to determine if the user prefers the second audio mode.

In some embodiments, the user may determine that a certain audio mode is how the final recording should be stored, the user may press a reprocess button, and the audio recording and playback system may begin processing in the background the entire audio and optionally video according to a last audio mode selected by the user. The user may continue listening and optionally watching or may stop (e.g., exit from an application), while the process continues to completion in the background. The user may track the background process status via the same or a different application.

In some embodiments, the background process may optionally be configured to delete the stored original acoustic sounds associated with the original video, for example, to save space in the karaoke recording system's memory. According to various embodiments, the karaoke recording system may also compress at least one of the audio sounds (e.g., the original acoustic sound, signal processed acoustic sounds, acoustic signals corresponding to one or more of the audio modes, and the like), for example, to conserve space in the karaoke recording system's memory. The user may upload (e.g., to a social media service, the cloud, and the like) the processed audio and video.

In some embodiments, the music track may be provided to a user through one or more transducers 270 (e.g., speakers, headphones, earbuds, and the like). In these embodiments, the acoustic sound being captured by microphones 220 and 230 may be mixed with the music track to be listened to by the user via the transducer(s) 270.

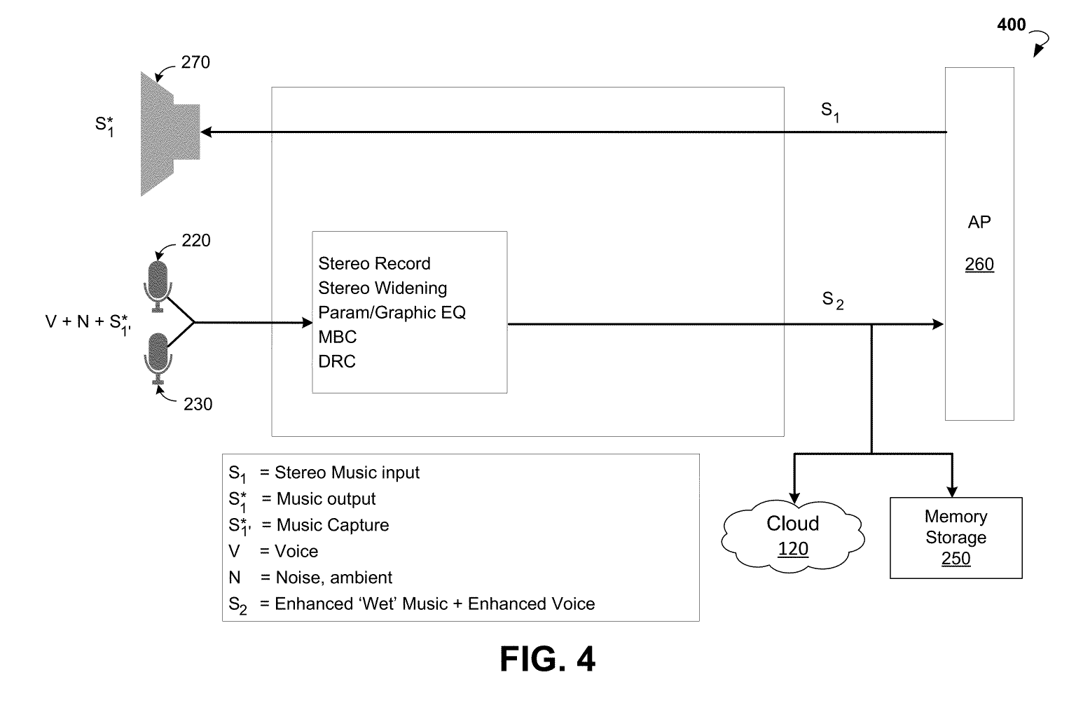

FIG. 4 is a block diagram of a system 400 for recording and playback on a mobile device, according to some embodiments. At least some of the operations of system 400 may be performed by audio processing system 260. The system 400 may comprise playing a music track S1 via transducer(s) 270 (e.g., speakers). The music track S1 may have a sampling rate of 48 kHz, for example, although 48 khz is just exemplary throughout this description, other suitable sampling rates may be used in some embodiments. The transducer(s) 270 may generate an acoustic music sound S*1. The system 400 may further comprise capturing acoustic sound via microphones 220 and 230. The acoustic sound may comprise a user's voice V, a noise N, and a music sound S*1′. The acoustic sound may be recorded to generate an output sound S2 in stereo mode with a sampling rate of 48 kHz. The output sound S2 may be further processed by applying filters using a parametric and graphic equalizer, multi-band compander, and dynamic range compression etc.. The output sound S2 may be stored in memory storage 250 or uploaded to a cloud 120.

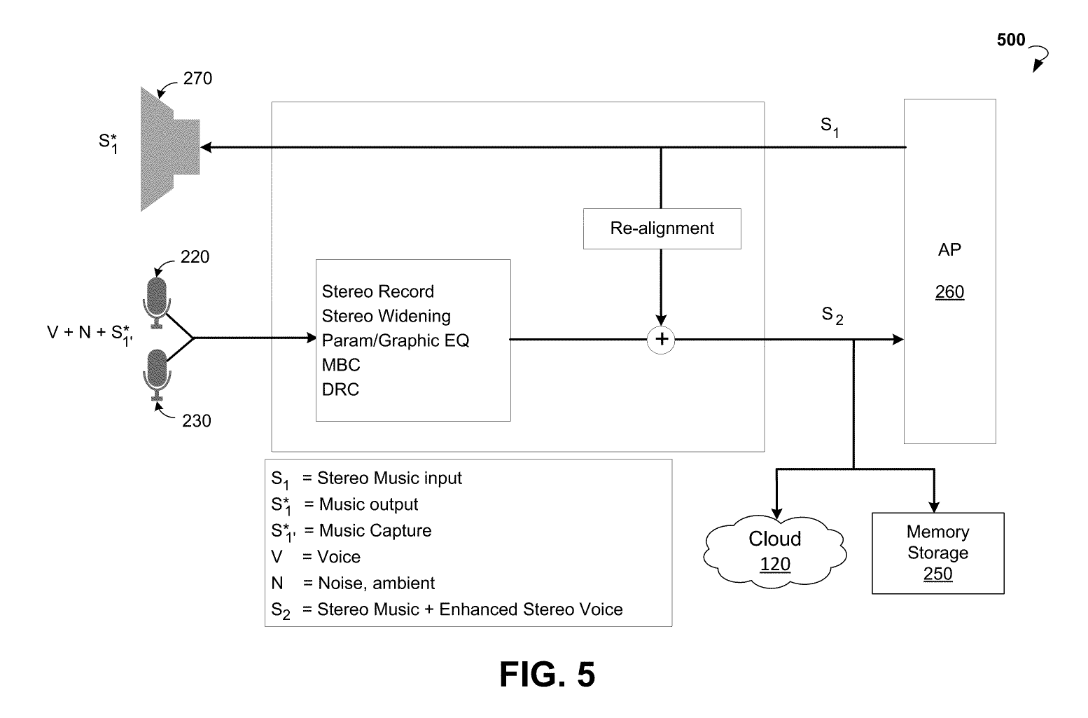

FIG. 5 is a block diagram of a system 500 for recording and playback on a mobile device, according to various embodiments. At least some of the operations of system 400 may be performed by audio processing system 260. The system 500 may be configured to play an input music track S1 via transducer(s) 270. The music track S1 may have a sampling rate of 48 kHz. The transducer(s) 270 may generate an acoustic music sound S*1. The system 500 may further capture acoustic sound via microphones 220 and 230. The acoustic sound may comprise a user's voice V, a noise N, and a music sound S*1′. The acoustic sound may be recorded to generate an output sound S2 in stereo mode with a sampling rate of 48 kHz. The output sound S2 may be further processed by applying filters using a parametric and graphic equalizer, multi-band compander and dynamic range compression, for example. The input music track S1 may be re-aligned and mixed with output sound S2. A user interface may be provided to receive mixing control options. The output sound S2 may be stored in memory storage 250 or uploaded to communications network 120.

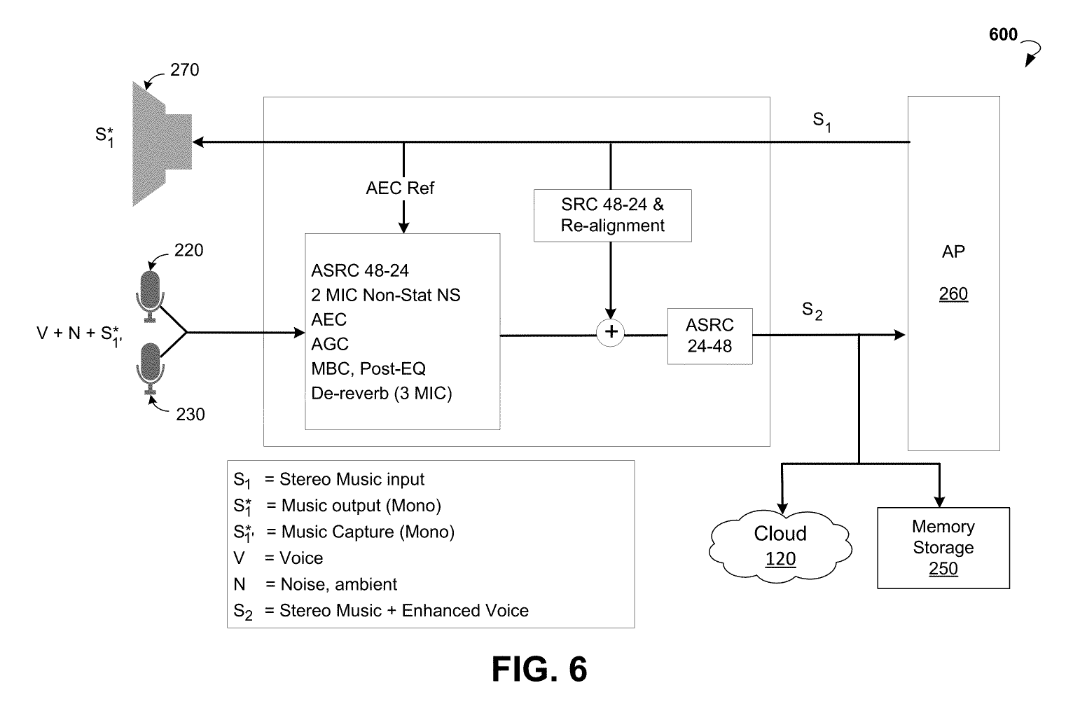

FIG. 6 is a block diagram of a system 600 for recording and playback on a mobile device, according to various embodiments. At least some of the operations of system 600 may be performed by audio processing system 260. The system 600 may be configured to play an input music track S1 via transducer(s) 270. The input music track S1 may have a sampling rate of 48 kHz. The transducer(s) 270 may generate an acoustic music sound S*1. The system 600 may further comprise capturing acoustic sound via microphones 220 and 230. The acoustic sound may comprise a user's voice V, a noise N, and a music sound S*1′. The acoustic sound may be recorded to generate an output sound S2 in a mono mode with a sampling rate of 24 kHz. The recording of the acoustic sound may include suppression of noise, acoustic echo cancelling, and automatic gain control. The reference signal for the echo cancellation may be provided from input music track S1.

The output sound S2 may be further processed by applying filters, for example, a parametric and graphic equalizer, multi-band compander, dereverbing, etc.. The input music track S1 may be resampled to rate of 24 kHz using an asynchronous sample rate conversion and re-aligned and mixed with the output sound S2. A user interface may be provided to receive mixing control options. The output sound S2 may be resampled to rate of 48 KHz. The output sound S2 may be stored in memory storage 250 or uploaded to a cloud 120.

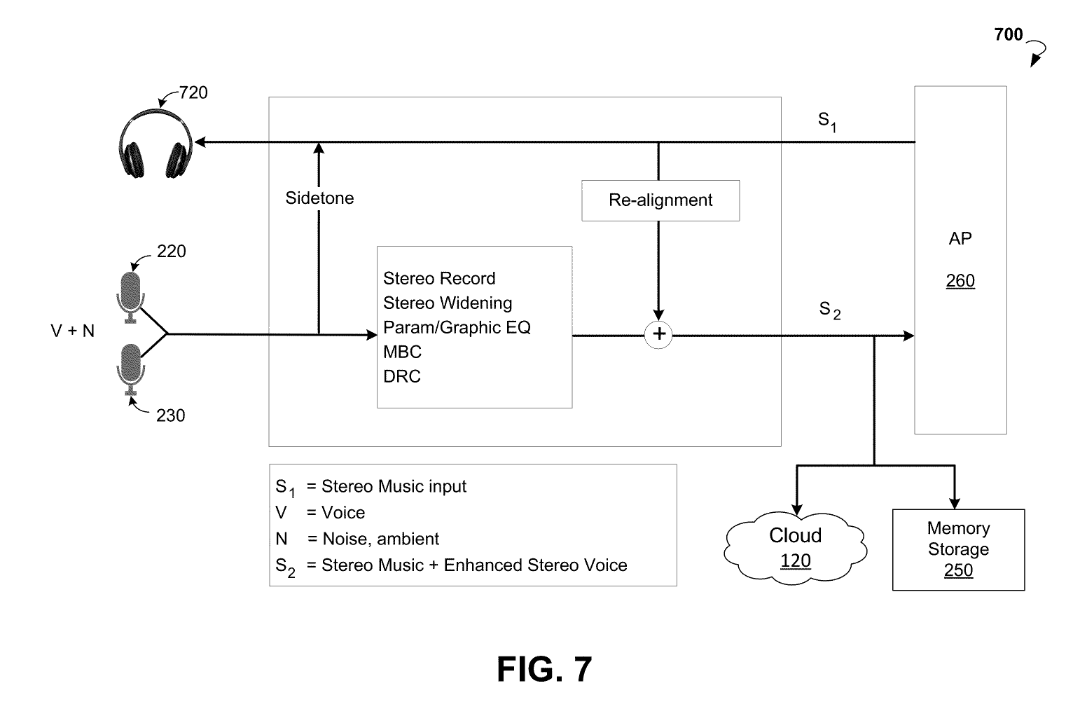

FIG. 7 is a block diagram of a system 700 for recording and playback on a mobile device, according to various embodiments. At least some of the operations of system 700 may be performed by audio processing system 260. The system 700 may be configured to play an input music track S1 via transducer(s) 270 to be listened to by a user. The input music track S1 may have a sampling rate of 48 kHz. The method 700 may further comprise capturing acoustic sound via microphones 220 and 230. The acoustic sound may comprise a user's voice V and a noise N. The acoustic sound may be recorded to generate an output sound S2 in stereo mode with a sampling rate of 48 kHz. The recorded output sound S2 may be provided to transducer(s) 270 (e.g., speakers, headphones, earbuds, and the like) as a sidetone to be listened to by the user.

The output sound S2 may be further processed by applying filters, for example, parametric and graphic equalizer, stereo widening multi-band compander, dynamic range compression, etc. The input music track S1 may be re-aligned and mixed with the output sound S2. A user interface may be provided to receive mixing control options. The output sound S2 may be stored, for example, in memory storage 250 or uploaded to a cloud 120.

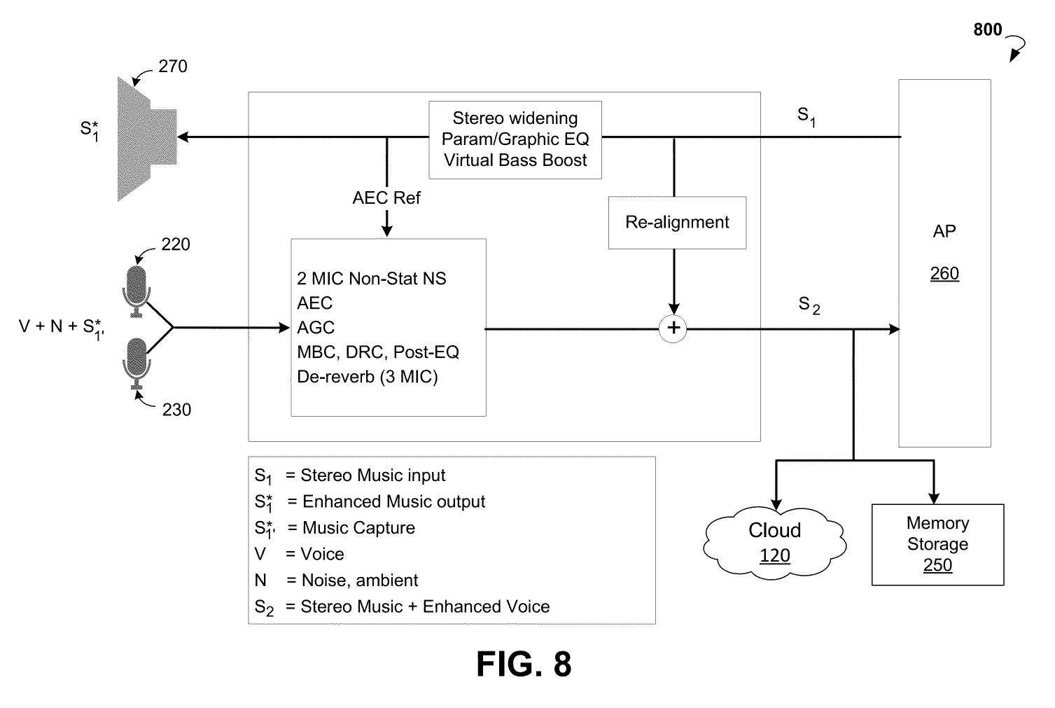

FIG. 8 is a block diagram of a system 800 for recording and playback on a mobile device, according to various embodiments. At least some of the operations of system 800 may be performed by audio processing system 260. The system 800 may be configured to play an input music track S1 via transducer(s) 270. The input music track S1 may have a sampling rate of 48 kHz. The transducer(s) 270 generate an acoustic music sound S*1. A user interface may be provided to receive playing control options. The input music track S1 may be adjusted by applying stereo widening, parametric and graphical equalizer filters, and virtual bass boost.

The system 800 may capture acoustic sound via microphones 220 and 230. The acoustic sound may comprise a user's voice V, a noise N, and a music S*1′. The acoustic sound may be recorded to generate an output sound S2 in stereo mode with a sampling rate of 48 kHz. The recording of the acoustic sound may include, for example, noise suppression, acoustic echo cancelling, automatic gain control, and de-reverbing. The reference signal for the echo cancellation may be provided from input music track S1. The output sound S2 may be further processed by applying filters using a parametric and graphic equalizer, multi-band compander, and dynamic range compression. The input music track S1 may be re-aligned and mixed with output sound S2. A user interface may be provided to receive mixing control options. The output sound S2 may be stored, for example, in memory storage 250 or uploaded to a cloud 120.

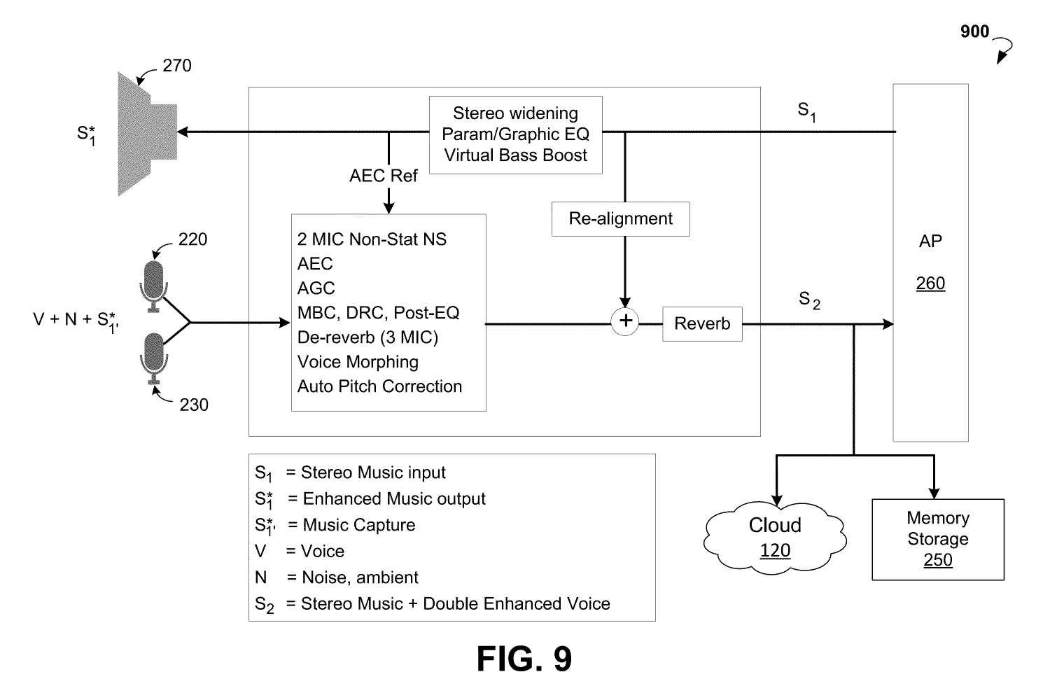

FIG. 9 is a block diagram of a system 900 for recording and playback on a mobile device, according to various embodiments. At least some of the operations of system 900 may be performed by audio processing system 260. The system 900 may be configured to play an input music track S1 via transducer(s) 270. The music track S1 may have a sampling rate of 48 kHz. The transducer(s) 270 generate an acoustic music sound S*1. A user interface may be provided to receive playing control options. The input music track S1 may be adjusted by applying stereo widening, parametric and graphical equalizer filters, and virtual bass boost.

The system 900 may capture acoustic sound via microphones 220 and 230. The acoustic sound may comprise a user's voice V, a noise N, and a music S*1′. The acoustic sound may be recorded to generate an output sound S2 in stereo mode with a sampling rate of 48 kHz. The recording of the acoustic sound may include noise suppression, acoustic echo cancelling, automatic gain control, and de-reverbing. The reference signal for the echo cancellation may be provided from input music track S1.

The output sound S2 may be further processed by applying filters, for example, parametric and graphic equalizer, multi-band compander, dynamic range compression, etc. A voice morphing and automatic pitch correction may be applied to the output sound S2 to enhance the voice component. A user interface may be provided to receive processing control options.

The input music track S1 may be re-aligned and mixed with output sound S2. A user interface may be provided to receive mixing control options. A reverbing may be further applied to output sound S2. The output sound S2 may be stored in memory storage 250 or uploaded to a cloud 120.

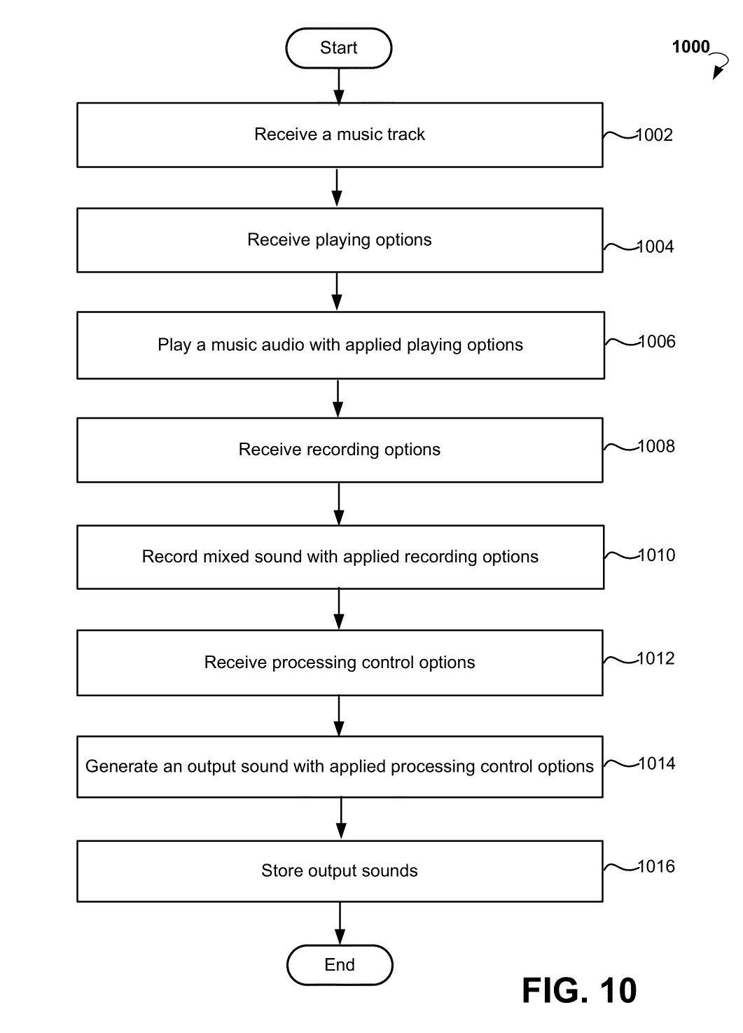

FIG. 10 is a flowchart diagram for a method 1000 for a karaoke recording on a mobile device, according to some embodiments. In some embodiments, the steps may be combined, performed in parallel, or performed in a different order. The method 1000 of FIG. 10 may also include additional or fewer steps than those illustrated. The method 1000 may be carried out by audio processing system 260 of FIG. 3. In step 1002, a music track S1 may be received. In step 1004, playing options may be received via a user interface. In step 1006, the received music track S1 may be played with applied playing options via speakers to produce acoustic music sound S*1. In step 1008, recording options may be received via a user interface. In step 1010, a mixed sound comprising a voice V, a noise N, and music sound S*1′ as captured by microphones may be recorded with applied recording options. In step 1012, processing control options may be received via a user interface. In step 1014, the mixed sound may be processed by applying the processing control options to generate an output sound S2. In step 1016, the output sound S2 may be stored (e.g., locally and/or in a cloud-based computing environment).

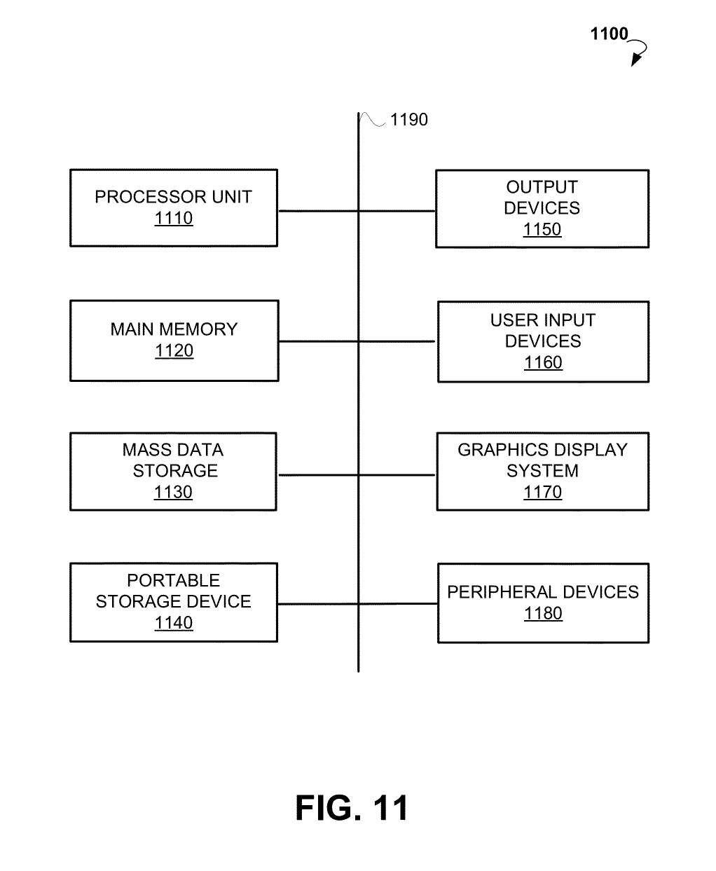

FIG. 11 illustrates an example computing system 1100 that may be used to implement embodiments of the present disclosure. The computing system 1100 of FIG. 11 may be implemented in the contexts of the likes of computing systems, networks, servers, or combinations thereof. The computing system 1100 of FIG. 11 includes one or more processor units 1110 and main memory 1120. Main memory 1120 stores, in part, instructions and data for execution by processor unit 1110. Main memory 1120 may store the executable code when in operation. The computing system 1100 of FIG. 11 further includes a mass storage device 1130, portable storage device 1140, output devices 1150, user input devices 1160, a graphics display system 1170, and peripheral devices 1180.

The components shown in FIG. 11 are depicted as being connected via a single bus 1190. The components may be connected through one or more data transport means. Processor unit 1110 and main memory 1120 may be connected via a local microprocessor bus, and the mass storage device 1130, peripheral device(s) 1180, portable storage device 1140, and graphics display system 1170 may be connected via one or more input/output (I/O) buses.

Mass storage device 1130, which may be implemented with a magnetic disk drive or an optical disk drive, is a non-volatile storage device for storing data and instructions for use by processor unit 1110. Mass storage device 1130 may store the system software for implementing embodiments of the present disclosure for purposes of loading that software into main memory 1120.

Portable storage device 1140 operates in conjunction with a portable non-volatile storage medium, such as a floppy disk, compact disk, digital video disc, or Universal Serial Bus (USB) storage device, to input and output data and code to and from the computing system 1100 of FIG. 11. The system software for implementing embodiments of the present disclosure may be stored on such a portable medium and input to the computing system 1100 via the portable storage device 1140.

Input devices 1160 provide a portion of a user interface. Input devices 1160 may include one or more microphones, an alphanumeric keypad, such as a keyboard, for inputting alphanumeric and other information, or a pointing device, such as a mouse, a trackball, stylus, or cursor direction keys. Input devices 1160 may also include a touchscreen. Additionally, the computing system 1100 as shown in FIG. 11 includes output devices 1150. Suitable output devices include speakers, printers, network interfaces, and monitors.

Graphics display system 1170 may include a liquid crystal display (LCD) or other suitable display device. Graphics display system 1170 receives textual and graphical information and processes the information for output to the display device.

Peripheral devices 1180 may include any type of computer support device to add additional functionality to the computer system.

The components provided in the computing system 1100 of FIG. 11 are those typically found in computer systems that may be suitable for use with embodiments of the present disclosure and are intended to represent a broad category of such computer components that are well known in the art. Thus, the computing system 1100 of FIG. 11 may be a personal computer (PC), hand held computing system, telephone, mobile computing system, workstation, server, minicomputer, mainframe computer, or any other computing system. The computer may also include different bus configurations, networked platforms, multi-processor platforms, and the like. Various operating systems may be used including UNIX, LINUX, WINDOWS, MAC OS, ANDROID, CHROME, IOS, QNX, and other suitable operating systems.

It is noteworthy that any hardware platform suitable for performing the processing described herein is suitable for use with the embodiments provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a Compact Disk Read Only Memory (CD-ROM) disk, digital video disk (DVD), BLU-RAY DISC (BD), any other optical storage medium, Random-Access Memory (RAM), Programmable Read-Only Memory (PROM), Erasable Programmable Read-Only Memory (EPROM), Electronically Erasable Programmable Read Only Memory (EEPROM), flash memory, and/or any other memory chip, module, or cartridge.

In some embodiments, the computing system 1100 may be implemented as a cloud-based computing environment, such as a virtual machine operating within a computing cloud. In other embodiments, the computing system 1100 may itself include a cloud-based computing environment, where the functionalities of the computing system 1100 are executed in a distributed fashion. Thus, the computing system 1100, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computing device 200, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

Thus systems and methods for karaoke on a mobile device have been disclosed. Present disclosure is described above with reference to example embodiments. Therefore, other variations upon the example embodiments are intended to be covered by the present disclosure.

What is claimed is:

1. A method for karaoke on a mobile device, the method comprising:
receiving via at least one microphone integral with a first mobile device:
an audio track comprising karaoke background music;
a voice acoustic signal from a user, and
background noise from an environment;
executing instructions, using a processor, to combine the received audio track, voice acoustic signal, and the background noise to produce a first combined signal;
performing processing on at least part of the first combined signal for reducing the background noise to produce a second combined signal, the signal processing comprising at least noise suppression and acoustic echo cancellation; and
storing the first and second combined signals, the first mobile device being configured such that the first and second combined acoustic signals may be transmitted via a communications network for listening on a second mobile device.

2. The method of claim 1, further comprising:
receiving, via a user interface provided by the mobile device, playing control options; and
playing, via one or more transducers, the audio track with applied one or more playing control options.

3. The method of claim 1, further comprising:
receiving, via the user interface provided by the mobile device, recording control options; and
storing the first combined signal with applied one or more of the recording control options, the storing comprising recording.

4. The method of claim 2, wherein playing control options comprise applying one or more of the following:
stereo widening;
a parametric and graphical equalizer;
a virtual bass control; and
reverbing.

5. The method of claim 3, wherein recording options comprise one or more of the following:
attenuating the background component in the at least one of the first and second combined signals;
attenuating the foreground component in the at least one of the first and second combined signals;
suppressing the audio track in the at least one of the first and second combined signals;
applying a directional audio effect;
applying automatic gain control; and
removing room dereverbation.

6. The method of claim 1, wherein the first mobile device is configured to provide the recording control options for at least one of the noise suppression and the acoustic echo cancellation.

7. The method of claim 1, further comprising playing a sidetone, the sidetone originating from at least one of the first and second combined signals.

8. The method of claim 1, further comprising receiving processing control options via a user interface provided by the first mobile device, the processing control options including one or more of the following:
realigning and mixing the first combined signal and the second combined signal;
applying automatic pitch correction;
applying asynchronous sample rate conversion;
applying dynamic range compression;
applying parametric and graphic equalizing;
applying multi-band companding;
applying voice morphing; and
removing room reverbation.

9. The method of claim 1, further comprising:
playing, via a graphic display system, a video associated with the audio track, the video comprising text, the text having lyrics associated with the audio track; and
storing video associated with the first or second combined signals; the mobile device being configured to transmit the stored video via a communications network.

10. The method of claim 1, wherein the processor is included in a cloud-based computing environment.

11. The method of claim 1, wherein the signal processing further comprises determining and storing audio cues associated with at least one of the first and second combined signals.

12. The method of claim 11, further comprising:
providing a post-processing mode and associated user interface for receiving input from a user of the mobile device to post-process the stored first and second combined signals.

13. The method of claim 12, further providing the stored audio cues for use during the post-processing mode.

14. The method of claim 12, further comprising receiving one or more additional noisy voice acoustic signals from other users via the first mobile device or other mobile devices communicatively coupled to the first mobile device via a communications network.

15. The method of claim 14, wherein the first combined signal comprises providing controls such that the user of the first mobile device can control playback and select between different audio modes, the audio modes including at least one mode for controlling mixing of stored noisy voice acoustic signals from the users.

16. The method of claim 6, further comprising providing for alignment and synchronization of received noisy voice acoustic signals.

17. The method of claim 1, further comprising:
storing the first and second combined signals on the first mobile device respectively, as first and second recordings.

18. The method of claim 17, further comprising:
receiving a third recording; and
mixing the first or second recording selectively with the third recording to produce a fourth recording, the fourth recording comprising a musical composition having at least two performers.

19. The method of claim 17, wherein a second audio portion associated with the third recording is different than a first audio portion associated with the first or second recordings, based on at least one of vocal audio and background audio.

20. The method of claim 19, wherein the mixing includes controlling a respective contribution of each of the first, second, and third recordings to the fourth recording.

21. The method of claim 20, wherein the mixing further includes at least one of adding sound effects to and changing one or more of a sound level, frequency content, dynamics, and panoramic position of the first, second, and/or third recordings.

22. The method of claim 17, further comprising:
providing the second recording via at least one output device;
receiving a selection from the user, the selection indicating at least one of an audio mode and a processing option;
storing a new recording comprising a changed second recording based at least on the selection; such that the new recording may be played back by the user of the mobile device; and
providing the stored new recording for use by the user.

23. The method of claim 22, wherein the audio mode includes at least one of a default, background and foreground, background, and foreground modes, so as to enable the user to select an amount of noise suppression and/or a direction of audio focus toward one or more singers.

24. The method of claim 23, wherein the processing option includes a media processing configuration.

25. The method of claim 24, wherein the media processing configuration include one or more of bass boost, multiband compression, stereo noise bias suppression, equalization, and pitch correction.

26. The method of claim 22, further comprising:
determining cues of the first and/or second recording;
altering the first and/or second recordings based at least in part on the cues and the selection received from the user; and
providing the altered first and/or second recording for use by the user.

27. The method of claim 26, wherein the cues include at least one of an inter-microphone level difference, level salience, pitch salience, signal type classification, and speaker identification.

28. A non-transitory machine readable medium having embodied thereon a program, the program providing instructions for a method for karaoke, the method comprising:
receiving via at least one microphone integral with a first mobile device:
an audio track comprising karaoke background music;
a voice acoustic signal from a user, and
background noise from an environment;
executing instructions, using a processor, to combine the received audio track, voice acoustic signal, and background noise to produce a first combined signal;
performing processing on at least part of the first combined signal for reducing the background noise to produce a second combined signal, the signal processing comprising at least noise suppression and acoustic echo cancellation; and
storing the first and second combined signals, the first mobile device being configured such that the first and second combined acoustic signals may be transmitted via a communications network for listening on a second mobile device.

29. A system for karaoke playback and recording, the system comprising
at least one mobile device comprising one or more microphones, a user interface, audio signal processor, and communications network interface, the mobile device further comprising
an audio input/output module stored in memory and executable by a processor to receive: an audio track comprising karaoke background music, a voice acoustic signal from a user, and background noise from an environment, via the one or more microphones;
a mixing module stored in memory and executable by a processor to combine the received audio track, voice signal acoustic signal, and background noise to produce a first combined signal;
a signal processing module configured to performing signal processing on at least part of the first combined signal to at least reduce the background noise in the noisy voice signal to produce a second combined signal, the signal processing comprising at least noise suppression and acoustic echo cancellation; and
a communications module stored in memory and executable by a processor to establish communications from the at least one mobile device to a communications network.

30. The system of claim 29, further comprising a memory module for storing the first and second combined signals on the first mobile device, the first mobile device being configured such that the stored first and second combined signals may be transmitted via the communications network for listening on at least one other mobile device.

31. The system of claim 29, wherein the system further provides one or more of playing control, recording control, and processing control options selectable via the user interface for providing respective options for the user of the mobile device to play, record, and process the first and second combined signals.
